(19) United States
(12) Patent Application Publication
(10) Pub. No.: US 2025/0338124 A1
(43) Pub. Date: Oct. 30, 2025

(54) POSITIONING METHOD AND APPARATUS, TERMINAL, CORE NETWORK DEVICE, AND ACCESS NETWORK DEVICE

(71) Applicant: VIVO MOBILE COMMUNICATION CO., LTD., Dongguan (CN)

(72) Inventor: Yuan LI, Dongguan (CN)

(73) Assignee: VIVO MOBILE COMMUNICATION CO., LTD., Dongguan (CN)

(21) Appl. No.: 19/260,340

(22) Filed: Jul. 4, 2025

Related U.S. Application Data
(63) Continuation of application No. PCT/CN2023/142550, filed on Dec. 28, 2023.

(30) Foreign Application Priority Data
Jan. 4, 2023 (CN) 202310009992.3

(51) Int. Cl. H04W 12/10; H04W 24/10; H04W 64/00

(52) U.S. Cl. CPC H04W 12/10; H04W 24/10; H04W 64/00

(57) ABSTRACT

A positioning method and apparatus, a terminal, a core network device, and an access network device are provided. The terminal receives first positioning assistance information from the core network device. The first positioning assistance information includes first indication information, and the first indication information is used to indicate at least one transmission reception point (TRP) that cannot be used for positioning integrity calculation, or the first indication information is used to indicate that assistance data related to a first error source cannot be used for positioning integrity calculation.

### CROSS-REFERENCE TO RELATED APPLICATIONS

This application is a continuation of International Application No. PCT/CN2023/142550, filed on Dec. 28, 2023, which claims priority to Chinese Patent Application No. 202310009992.3, filed on Jan. 4, 2023. The entire contents of each of the above-referenced applications are expressly incorporated herein by reference.

### TECHNICAL FIELD

This application pertains to the field of communications technologies, and specifically relates to a positioning method and apparatus, a terminal, a core network device, and an access network device.

### BACKGROUND

In a positioning method based on a wireless technology, sources that may cause positioning errors include an entity providing a measurement quantity and an entity providing assistance data. When a positioning request includes a positioning integrity requirement, these entities need to provide an entity calculating positioning integrity with integrity information (for example, integrity bounds of a measurement quantity and assistance data) related to the error source, to calculate positioning integrity. However, in actual cases, the integrity information related to the error source may not all be used to calculate positioning integrity. In a case that unreliable information is used to evaluate positioning integrity, reliability of final obtained positioning integrity is poor.

### SUMMARY

Embodiments of this application provide a positioning method and apparatus, a terminal, a core network device, and an access network device, which can improve accuracy of a calculation result of positioning integrity in the positioning method that is based on a wireless technology.

According to a first aspect, a positioning method is provided. The method includes:

A terminal receives first positioning assistance information from a core network device, or the terminal sends first positioning measurement information to the core network device, where
the first positioning assistance information includes first indication information, and the first indication information is used to indicate at least one Transmission Reception Point (TRP) that cannot be used for positioning integrity calculation, or the first indication information is used to indicate that assistance data related to a first error source cannot be used for positioning integrity calculation; and
the first positioning measurement information includes second indication information, and the second indication information is used to indicate that assistance data related to a second error source cannot be used for positioning integrity calculation.

According to a second aspect, a positioning apparatus is provided. The apparatus includes:
a first transmission module, configured to receive first positioning assistance information from a core network device, or send first positioning measurement information to the core network device, where
the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; and
the first positioning measurement information includes second indication information, and the second indication information is used to indicate that assistance data related to a second error source cannot be used for positioning integrity calculation.

According to a third aspect, a positioning method is provided. The method includes:

A core network device sends first positioning assistance information to a terminal, or the core network device receives first positioning measurement information from the terminal, or the core network device receives second positioning measurement information from an access network device, where
the first positioning assistance information includes first indication information, and the first indication information is used to indicate at least one TRP that cannot be used for positioning integrity calculation, or the first indication information is used to indicate that assistance data related to a first error source cannot be used for positioning integrity calculation;
the first positioning measurement information includes second indication information, and the second indication information is used to indicate that assistance data related to a second error source cannot be used for positioning integrity calculation; and
the second positioning measurement information includes fourth indication information, and the fourth indication information is used to indicate that assistance data related to a third error source cannot be used for positioning integrity calculation.

According to a fourth aspect, a positioning apparatus is provided. The apparatus includes:
a second transmission module, configured to send first positioning assistance information to a terminal, or receive first positioning measurement information from the terminal, or receive second positioning measurement information from an access network device, where
the first positioning assistance information includes first indication information, and the first indication information is used to indicate at least one TRP that cannot be used for positioning integrity calculation, or the first indication information is used to indicate that assistance data related to a first error source cannot be used for positioning integrity calculation;
the first positioning measurement information includes second indication information, and the second indication information is used to indicate that assistance data related to a second error source cannot be used for positioning integrity calculation; and
the second positioning measurement information includes fourth indication information, and the fourth indication information is used to indicate that assistance data related to a third error source cannot be used for positioning integrity calculation.

According to a fifth aspect, a positioning method is provided. The method includes:

An access network device sends second positioning measurement information to a core network device, where
the second positioning measurement information includes fourth indication information, and the fourth indication information is used to indicate that assistance data related to a third error source cannot be used for positioning integrity calculation.

According to a sixth aspect, a positioning apparatus is provided. The apparatus includes:
a first sending module, configured to send second positioning measurement information to a core network device, where
the second positioning measurement information includes fourth indication information, and the fourth indication information is used to indicate that assistance data related to a third error source cannot be used for positioning integrity calculation.

According to a seventh aspect, a terminal is provided. The terminal includes a processor and a memory, the memory stores a program or an instruction that is executable on the processor, and the program or the instruction is executed by the processor to implement the steps of the method according to the first aspect.

According to an eighth aspect, a terminal is provided, including a processor and a communication interface, where the communication interface is configured to receive first positioning assistance information from a core network device, or send first positioning measurement information to the core network device, where the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; and the first positioning measurement information includes second indication information, and the second indication information is used to indicate that assistance data related to a second error source cannot be used for positioning integrity calculation.

According to a ninth aspect, a core network device is provided. The core network device includes a processor and a memory, the memory stores a program or an instruction that is executable on the processor, and the program or the instruction is executed by the processor to implement the steps of the method according to the third aspect.

According to a tenth aspect, a core network device is provided, including a processor and a communication interface, where the communication interface is configured to send first positioning assistance information to a terminal, or receive first positioning measurement information from the terminal, or receive second positioning measurement information from an access network device, where the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; the first positioning measurement information includes second indication information, and the second indication information is used to indicate that assistance data related to a second error source cannot be used for positioning integrity calculation; and the second positioning measurement information includes fourth indication information, and the fourth indication information is used to indicate that assistance data related to a third error source cannot be used for positioning integrity calculation.

According to an eleventh aspect, an access network device is provided. The access network device includes a processor and a memory, the memory stores a program or an instruction that is executable on the processor, and the program or the instruction is executed by the processor to implement the steps of the method according to the fifth aspect.

According to a twelfth aspect, an access network device is provided, including a processor and a communication interface, where the communication interface is configured to send second positioning measurement information to a core network device, where the second positioning measurement information includes fourth indication information, and the fourth indication information is used to indicate that assistance data related to a third error source cannot be used for positioning integrity calculation.

According to a thirteenth aspect, a positioning system is provided, including a terminal and a core network device. The terminal may be configured to perform the steps of the positioning method according to the first aspect, and the core network device may be configured to perform the steps of the positioning method according to the third aspect.

According to a fourteenth aspect, a readable storage medium is provided. The readable storage medium stores a program or an instruction, and when the program or the instruction is executed by a processor, the steps of the method according to the first aspect are implemented, or the steps of the method according to the third aspect are implemented, or the steps of the method according to the fifth aspect are implemented.

According to a fifteenth aspect, a chip is provided. The chip includes a processor and a communication interface. The communication interface is coupled to the processor. The processor is configured to run a program or an instruction, to implement the steps of the method according to the first aspect, the steps of the method according to the third aspect, or the steps of the method according to the fifth aspect.

According to a sixteenth aspect, a computer program/program product is provided. The computer program/program product is stored in a storage medium, and the computer program/program product is executed by at least one processor to implement the steps of the method according to the first aspect, the steps of the method according to the third aspect, or the steps of the method according to the fifth aspect.

In the embodiments of this application, the terminal receives the first positioning assistance information from the core network device, or the terminal sends the first positioning measurement information to the core network device, where the first positioning assistance information includes the first indication information, and the first indication information is used to indicate the at least one TRP that cannot be used for positioning integrity calculation, or the first indication information is used to indicate that the assistance data related to the first error source cannot be used for positioning integrity calculation; and the first positioning measurement information includes the second indication information, and the second indication information is used to indicate that the assistance data related to the second error source cannot be used for positioning integrity calculation. That is, the core network device indicates to the terminal the at least one TRP or the assistance data, related to the first error source, that cannot be used for positioning integrity calculation, or the terminal indicates to the core network device the assistance data, related to the second error source, that cannot be used for positioning integrity calculation. In this way, in a process of calculating positioning integrity, the indicated TRP or the indicated assistance data that cannot be used for positioning integrity calculation may not be considered, and accuracy of the calculation result of positioning integrity in the positioning method that is based on the wireless technology can be further improved.

### BRIEF DESCRIPTION OF DRAWINGS

FIG. 1 is a block diagram of a wireless communication system to which embodiments of this application are applicable;

FIG. 2 is a schematic diagram of error probability density distribution according to an embodiment of this application;

FIG. 3 is a schematic diagram of an alert limit cylinder and a protection level cylinder according to an embodiment of this application;

FIG. 4 is a flowchart of a positioning method according to an embodiment of this application;

FIG. 5 is a flowchart of another positioning method according to an embodiment of this application;

FIG. 6 is a flowchart of still another positioning method according to an embodiment of this application;

FIG. 7 is a structural diagram of a positioning apparatus according to an embodiment of this application;

FIG. 8 is a structural diagram of another positioning apparatus according to an embodiment of this application;

FIG. 9 is a structural diagram of still another positioning apparatus according to an embodiment of this application;

FIG. 10 is a structural diagram of a communication device according to an embodiment of this application;

FIG. 11 is a structural diagram of a terminal according to an embodiment of this application; and
FIG. 12 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

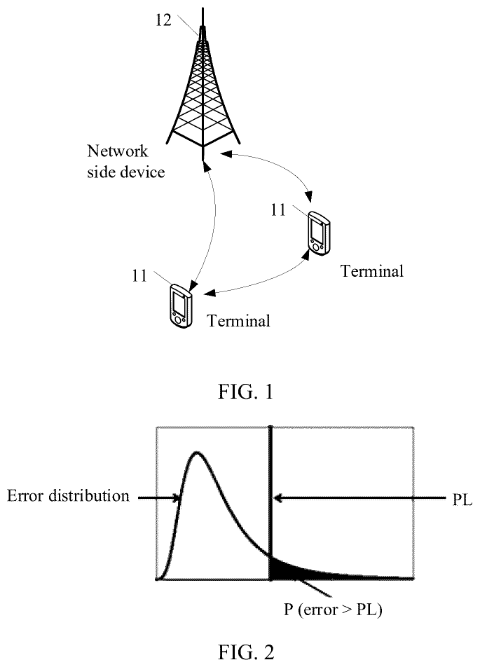

FIG. 1 is a block diagram of a wireless communication system to which embodiments of this application are applicable. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Location Management Function (LMF) network element, a Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), and the like. It should be noted that, in the embodiments of this application, only a core network device in an NR system is used as an example for description, and a specific type of the core network device is not limited.

For ease of understanding, some content involved in the embodiments of this application is described below.

### I. Positioning Integrity

Positioning integrity is a method used to measure whether location-related data provided by a positioning system is accurate, and when the system does not meet an integrity requirement, has a function of providing a timely and reliable alert (whether the system is available) to a client requesting a location service.

### 1. Basic Operation Principle for Positioning Integrity

(1) The client requesting the location service (location services client, LCS client) provides integrity requirements to an LMF, for example, a Target Integrity Risk (TIR), an Alert Limit (AL), Time-to-Alert (TTA).

TIR: is a probability that a positioning error exceeds the alert limit (AL) and a user fails to be alerted within the required time-to-alert (TTA). The TIR is usually defined as a probability per time unit (for example, per hour).

The TIR provided by the LCS client is a requirement of the LCS client for a target integrity risk of a system, that is, optimal integrity performance that the LCS client expects the system to achieve. For example, TIR=10⁻⁷/hr indicates that the system is expected to generate harmful misleading information for system availability evaluation only once within 10000000 hours. A meaning of the harmful misleading information is that an actual positioning error has exceeded the alert limit, but a protection level inferred based on a feared event is still less than the alert limit (PL<AL<PE).

AL: is a maximum allowable positioning error that the positioning system can be used for predetermined application. When the AL limits the positioning error on a horizontal plane or a vertical plane, the AL is respectively referred to as a Horizontal Alert Limit (HAL) or a Vertical Alert Limit (VAL).

TTA: is maximum allowable operating time from a time point at which the positioning error exceeds the alert limit (AL) to a time point at which a corresponding alert is finally issued.

(2) An entity that calculates positioning integrity comprehensively considers feared events provided by all possible error sources and calculates a Protection Level (PL) according to the TIR. A physical meaning of the protection level is to ensure that the actual positioning error is within a range of the protection level on the premise that the target integrity risk of the system meets the requirement.

Entities that may become error sources provide all feared events that may cause positioning inaccuracy to the entity that calculates positioning integrity. After comprehensively considering these feared events, the entity that calculates positioning integrity obtains probability distribution of positioning errors based on implementation of the entity that calculates positioning integrity, for example, error probability density distribution shown in FIG. 2, and calculates the PL based on the required target integrity risk TIR of the system: On the premise of not exceeding the TTA, the actual positioning error within unit time is greater than the AL and a probability of PL<AL is less than the TIR.

Feared events are all events that may cause a calculated location to deviate from an actual location (for example, natural, manual, systematic or operational), regardless of whether a specific fault can be determined in one positioning system through the feared event.

(3) The LMF compares a size relationship between the PL (where the actual location needs to be within a cylinder drawn by the PL shown in FIG. 3) and the AL: In a case that the PL is less than the AL, the LMF indicates to the LCS client that the positioning system is available; or in a case that the PL is greater than the AL, the LMF indicates to the LCS client that location estimation provided by the positioning system does not have integrity.

### II. R17 Satellite Positioning Integrity

R17 Global Navigation Satellite System (GNSS) integrity currently supports only terminal-based positioning integrity calculation, that is, an entity that calculates a positioning integrity result is a terminal. It is considered that a feared event that may cause a positioning error is introduced by only satellite correction data. Because the satellite correction data is provided to the terminal through an LMF, an error source causing the feared event is assistance data provided by the LMF to the terminal.

The LMF includes, in the assistance data, a list GNSS-RealTimeIntegrity used to indicate bad satellite or space vehicle signals (in a case that a bad signal is included in the list, the UE does not consider integrity data related to the signal when calculating positioning integrity) and an alert used to indicate a positioning integrity service level (that is, “the ionosphere is not used” (ionosphereDoNotUse-r17) and “the troposphere is not used” (troposphereDoNotUse-r17)). In a case that the LMF indicates the alert, the UE does not consider using correction data corresponding to the ionosphere or the troposphere when calculating positioning integrity.

It should be noted that integrity evaluation of the positioning system is introduced in wireless access technology-based positioning. When a possible error source and a feared event caused by the error source are identified, entities related in different positioning methods, that is, measurement quantities and assistance data that affect positioning result calculation in different positioning methods, need to be considered. On this basis, how to indicate whether the feared event can be used to evaluate positioning integrity, and considering characteristics of a wireless positioning technology, how to indicate, at different granularities, whether the feared event can be used to evaluate positioning integrity are urgent problems to be resolved. For example, in the wireless access technology-based positioning methods, related entities include the terminal, the access network device (such as the base station), and the core network device (such as the LMF), and transmission processes that may affect the positioning result include: The measurement entity (the terminal or the access network device) reports the measurement value of the measurement quantity, the access network device provides TRP information, and the LMF provides the assistance data. Based on the foregoing consideration, in the embodiments of this application, whether the error source or the feared event related to the error source can be used for evaluation of positioning integrity is indicated at different granularities from perspectives of different entities that calculate positioning integrity.

With reference to the accompanying drawings, a positioning method provided in the embodiments of this application is described in detail by using some embodiments and application scenarios thereof.

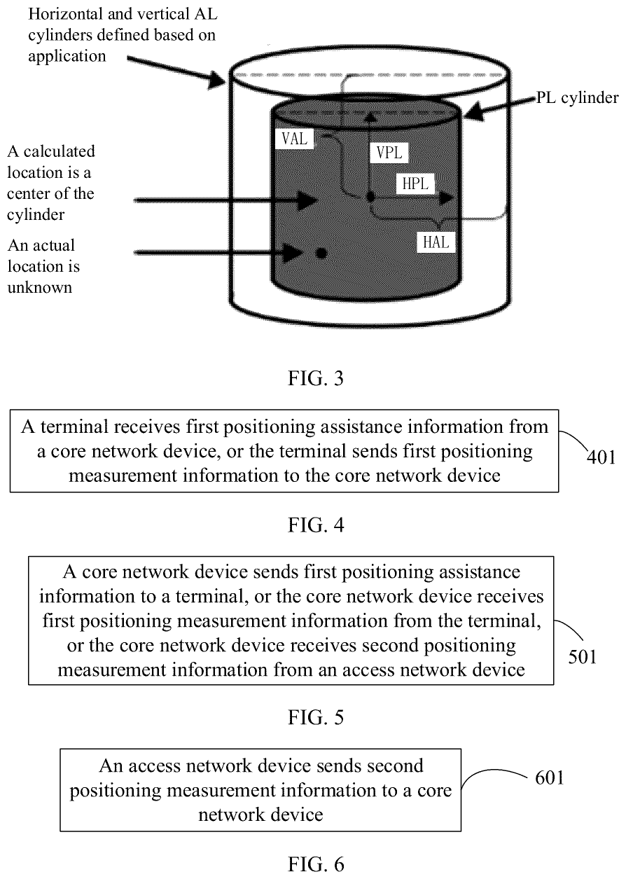

Referring to FIG. 4, FIG. 4 is a flowchart of a positioning method according to an embodiment of this application. The method may be performed by a terminal. As shown in FIG. 4, the method includes the following steps.

Step 401: The terminal receives first positioning assistance information from a core network device, or the terminal sends first positioning measurement information to the core network device, where
the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; and
the first positioning measurement information includes second indication information, and the second indication information is used to indicate that assistance data related to a second error source cannot be used for positioning integrity calculation.

In an implementation, the terminal receives the first positioning assistance information from the core network device. For example, in a case that the terminal performs positioning integrity calculation and/or the terminal performs positioning measurement, the terminal receives the first positioning assistance information from an LMF. For example, the first positioning assistance information may be carried in an LTE Positioning Protocol (LPP) message. For example, the first positioning assistance information may be carried in a provide assistance data message.

The first positioning assistance information includes the first indication information, and the first indication information is used to indicate the at least one TRP that cannot be used for positioning integrity calculation. For example, the first indication information may include an identifier of the at least one TRP that cannot be used for positioning integrity calculation (that is, a TRP ID). In other words, unavailability of positioning integrity information is indicated at a granularity of the TRP. In this case, a calculation entity of positioning integrity may not perform positioning integrity calculation by using assistance data related to the at least one TRP and/or a measurement quantity related to the at least one TRP. In some embodiments, the first indication information is used to indicate that the assistance data related to the first error source (for example, assistance data included in the first error source) cannot be used for positioning integrity calculation. In other words, unavailability of positioning integrity information is indicated at a granularity of the error source. In this case, a calculation entity of positioning integrity may not perform positioning integrity calculation by using the assistance data related to the first error source.

In some optional embodiments, an application range of the at least one TRP that cannot be used for positioning integrity calculation may be predefined in a protocol. For example, it may be predefined in the protocol that the application range of the at least one TRP is the assistance data, that is, the assistance data related to the at least one TRP cannot be used for positioning integrity calculation, or it may be predefined in the protocol that the application range of the at least one TRP is the measurement quantity, that is, a first measurement quantity related to the at least one TRP cannot be used for positioning integrity calculation. In some embodiments, the application range of the at least one TRP may be determined according to implementation of the terminal. For example, in a case that the terminal performs only positioning measurement (for instance, terminal-assisted positioning calculation), the application range of the at least one TRP is the measurement quantity. In a case that the terminal performs positioning integrity calculation (for example, terminal-based positioning calculation), the application range of the at least one TRP may include the assistance data and the measurement quantity. In some embodiments, the application range of the at least one TRP is indicated by the core network device.

In some optional embodiments, the first indication information may be updated in real time. For example, the core network device may update the first indication information according to a preset update cycle, where an upper limit of the preset update cycle may be a TTA, or the core network device may update the first indication information based on occurrence of a feared event caused by the first error source.

For example, the first error source may include at least one of the following:
a TRP location (that is, TRP location);
inter-TRP time synchronization (that is, inter-TRP synchronization);
a boresight direction of a Positioning Reference Signal (PRS) (that is, boresight direction of PRS); and
beam information of a PRS (that is, beam information of PRS).

It should be noted that the PRS may be a Downlink (DL) PRS, for example, a PRS sent by an access network device to the terminal.

For example, the assistance data related to the first error source may include at least one of the following:
a positioning integrity bound (that is, integrity bound) of the first error source; and
a positioning integrity parameter (that is, integrity parameter) of the first error source.

For example, the positioning integrity bound of the first error source may include but is not limited to a mathematical expectation used to provide the feared event caused by the first error source (for example, a mean value and a variance of probability distribution of feared events). The positioning integrity parameter of the first error source may be used to calculate a residual risk of the feared event caused by the first error source, for example, may include but is not limited to a start probability of the feared event and average duration of the feared event. The feared event may be the feared event caused by the first error source.

In another implementation, the terminal sends the first positioning measurement information to the core network device. For example, in a case that the terminal performs positioning measurement and the LMF performs positioning integrity calculation, the terminal may send the first positioning measurement information to the LMF. For example, the first positioning measurement information may be carried in an LPP message. For example, the first positioning measurement information may be carried in a provide location information message.

The first positioning measurement information includes the second indication information, and the second indication information is used to indicate that the assistance data related to the second error source (for example, assistance data included in the second error source) cannot be used for positioning integrity calculation. In other words, unavailability of positioning integrity information is indicated at a granularity of the error source. In this case, a calculation entity of positioning integrity may not perform positioning integrity calculation by using the assistance data related to the second error source.

For example, the second error source may include at least one of the following:
a Reference Signal Timing Difference (RSTD); and
a receive-transmit timing difference of the terminal (that is, Rx-Tx Timing Difference).

It should be noted that the reference signal may be a DL-PRS, for example, a PRS sent by an access network device to the terminal.

For example, the assistance data related to the second error source may include at least one of the following:
a positioning integrity bound of the second error source; and
a positioning integrity parameter of the second error source.

For example, the positioning integrity bound of the second error source may include but is not limited to a mathematical expectation used to provide a feared event caused by the second error source (for example, a mean value and a variance of probability distribution of feared events). The positioning integrity parameter of the second error source may be used to calculate a residual risk of the feared event caused by the second error source, for example, may include but is not limited to a start probability of the feared event and average duration of the feared event. The feared event may be the feared event caused by the second error source.

According to the positioning method provided in this embodiment of this application, the terminal receives the first positioning assistance information from the core network device, or the terminal sends the first positioning measurement information to the core network device, where the first positioning assistance information includes the first indication information, and the first indication information is used to indicate the at least one TRP that cannot be used for positioning integrity calculation, or the first indication information is used to indicate that the assistance data related to the first error source cannot be used for positioning integrity calculation; and the first positioning measurement information includes the second indication information, and the second indication information is used to indicate that the assistance data related to the second error source cannot be used for positioning integrity calculation. That is, the core network device indicates to the terminal the at least one TRP or the assistance data, related to the first error source, that cannot be used for positioning integrity calculation, or the terminal indicates to the core network device the assistance data, related to the second error source, that cannot be used for positioning integrity calculation. In this way, in a process of calculating positioning integrity, the indicated TRP or the indicated assistance data that cannot be used for positioning integrity calculation may not be considered, and reliability of the calculation result of positioning integrity in the positioning method that is based on the wireless technology can be further improved.

For example, in a case that the first indication information is used to indicate the at least one TRP that cannot be used for positioning integrity calculation, the terminal does not calculate positioning integrity by using assistance data related to the at least one TRP; or
in a case that the first indication information is used to indicate that the assistance data related to the first error source cannot be used for positioning integrity calculation, the terminal does not calculate positioning integrity by using the assistance data related to the first error source.

In an implementation, in the case that the first indication information is used to indicate the at least one TRP that cannot be used for positioning integrity calculation, the terminal may not calculate positioning integrity by using the assistance data related to the at least one TRP. For example, the assistance data related to the at least one TRP may include assistance data related to a fourth error source corresponding to the at least one TRP. The fourth error source may include but is not limited to at least one of the following: a TRP position, inter-TRP time synchronization; a boresight direction of a PRS; and beam information of a PRS. The assistance data of the fourth error source may include but is not limited to at least one of the following: a positioning integrity bound of the fourth error source; and a positioning integrity parameter of the fourth error source.

In another implementation, in the case that the first indication information is used to indicate that the assistance data related to the first error source cannot be used for positioning integrity calculation, the terminal may not calculate positioning integrity by using the assistance data related to the first error source.

It should be noted that in this embodiment, the terminal may perform positioning integrity measurement. For example, the terminal measures the PRS from the access network device and may calculate positioning integrity based on a measurement value of the first measurement quantity.

For example, the first positioning assistance information further includes third indication information, and the third indication information is used to indicate at least one of the following:
assistance data related to the at least one TRP cannot be used for positioning integrity calculation; and
a first measurement quantity related to the at least one TRP cannot be used for positioning integrity calculation.

In this embodiment, an application range of the at least one TRP may be indicated by using the third indication information. For example, the application range may include the assistance data related to the at least one TRP and the measurement quantity related to the at least one TRP. That is, the third indication information is used to indicate at least one of the following: the assistance data related to the at least one TRP cannot be used for positioning integrity calculation, and the first measurement quantity related to the at least one TRP cannot be used for positioning integrity calculation.

For the assistance data related to the at least one TRP, refer to the related descriptions of the foregoing embodiment. Details are not described herein again.

For example, the first measurement quantity may include at least one of the following:
a reference signal timing difference;
a Reference Signal Received Power (RSRP);
a Reference Signal Path Received Power (RSRPP); and
a receive-transmit timing difference of the terminal.

In this embodiment, the reference signal may be a DL-PRS.

In some optional embodiments, in a case that the first indication information is used to indicate the at least one TRP that cannot be used for positioning integrity calculation and the third indication information indicates that the first measurement quantity related to the at least one TRP cannot be used for positioning integrity calculation, the terminal does not calculate positioning integrity by using the assistance data related to the at least one TRP, and the terminal does not measure the first measurement quantity related to the at least one TRP, or the terminal does not calculate positioning integrity by using the measurement value of the first measurement quantity related to the at least one TRP.

For example, in a case that the terminal performs positioning integrity calculation and the third indication information is used to indicate that the assistance data related to the at least one TRP cannot be used for positioning integrity calculation, the terminal does not calculate positioning integrity by using the assistance data related to the at least one TRP; and/or
in a case that the terminal performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not calculate positioning integrity by using a measurement value of the first measurement quantity related to the at least one TRP; and/or
in a case that the core network device performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not report a measurement value of the first measurement quantity related to the at least one TRP.

In an implementation, in the case that the terminal performs positioning integrity calculation and the third indication information is used to indicate that the assistance data related to the at least one TRP cannot be used for positioning integrity calculation, the terminal does not calculate positioning integrity by using the assistance data related to the at least one TRP indicated by the first indication information. For example, the UE does not calculate positioning integrity by using the assistance data, from the LMF, related to the at least one TRP indicated by the first indication information.

In another implementation, in the case that the terminal performs positioning integrity calculation and the third indication information is used to indicate that the first measurement quantity related to the at least one TRP cannot be used for positioning integrity calculation, the terminal may not measure the first measurement quantity related to the at least one TRP indicated by the first indication information, or the terminal does not calculate positioning integrity by using the measurement value of the first measurement quantity related to the at least one TRP indicated by the first indication information. In this case, the terminal may measure the first measurement quantity, but does not calculate positioning integrity by using the measurement value of the first measurement quantity.

In still another implementation, in the case that the terminal performs positioning measurement or positioning integrity measurement, the core network device performs positioning integrity calculation, and the third indication information is used to indicate that the first measurement quantity related to the at least one TRP cannot be used for positioning integrity calculation, the terminal may not measure the first measurement quantity related to the at least one TRP, or the terminal does not report the measurement value of the first measurement quantity related to the at least one TRP. In this case, the terminal may measure the first measurement quantity, but does not report the measurement value of the first measurement quantity to the core network device. As a result, the core network device cannot calculate positioning integrity by use the measurement value of the first measurement quantity.

It should be noted that in a case that the assistance data related to the at least one TRP, the first measurement quantity related to the at least one TRP, the assistance data related to the first error source, and the like cannot be used for positioning integrity calculation, this embodiment does not limit whether the assistance data related to the at least one TRP, the first measurement quantity related to the at least one TRP, the assistance data related to the first error source, and the like can be used for positioning result calculation. For example, the assistance data related to the at least one TRP, the first measurement quantity related to the at least one TRP, the assistance data related to the first error source, and the like can still be used to calculate a positioning result.

Referring to FIG. 5, FIG. 5 is a flowchart of a positioning method according to an embodiment of this application. The method may be performed by a core network device. As shown in FIG. 5, the method includes the following steps.

Step 501: The core network device sends first positioning assistance information to a terminal, or the core network device receives first positioning measurement information from the terminal, or the core network device receives second positioning measurement information from an access network device, where
the first positioning assistance information includes first indication information, and the first indication information is used to indicate at least one TRP that cannot be used for positioning integrity calculation, or the first indication information is used to indicate that assistance data related to a first error source cannot be used for positioning integrity calculation;
the first positioning measurement information includes second indication information, and the second indication information is used to indicate that assistance data related to a second error source cannot be used for positioning integrity calculation; and
the second positioning measurement information includes fourth indication information, and the fourth indication information is used to indicate that assistance data related to a third error source cannot be used for positioning integrity calculation.

It should be noted that for the first positioning assistance information and the first positioning measurement information in this embodiment, refer to the related descriptions of the foregoing embodiment. Details are not described herein again.

In a case that the access network device (such as a base station) performs measurement, the access network device may send the second positioning measurement information to the core network devices (such as an LMF), so that the core network device may perform positioning integrity calculation based on the second positioning measurement information. For example, the second positioning measurement information may be carried in an NR Positioning Protocol A (NRPPa) message. For example, the second positioning measurement information may be carried in a measurement report message.

The second positioning measurement information includes the fourth indication information, and the fourth indication information is used to indicate that the assistance data related to the third error source cannot be used for positioning integrity calculation. In other words, unavailability of positioning integrity information is indicated at a granularity of the error source. In this case, the core network device may not perform positioning integrity calculation by using the assistance data related to the third error source.

For example, the third error source may include at least one of the following:
a reference signal Time of Arrival (TOA);
a receive-transmit timing difference of the access network device (that is, Rx-Tx Timing Difference); and
a reference signal Angle of Arrival (AOA).

In this embodiment, the reference signal may be a Sounding Reference Signal (SRS) transmitted by the terminal, for example, a UL-SRS. The reference signal time of arrival may be a Relative Time of Arrival (RTOA) of the UL-SRS. The reference signal angle of arrival may be an angle of arrival of the UL-SRS.

For example, the assistance data related to the third error source includes at least one of the following:
a positioning integrity bound of the third error source; and
a positioning integrity parameter of the third error source.

For example, the positioning integrity bound of the third error source may include but is not limited to a mathematical expectation used to provide a feared event caused by the third error source (for example, a mean value and a variance of probability distribution of feared events). The positioning integrity parameter of the third error source may be used to calculate a residual risk of the feared event caused by the third error source, for example, may include but is not limited to a start probability of the feared event and average duration of the feared event. The feared event may be the feared event caused by the third error source.

For example, the first positioning assistance information further includes third indication information, and the third indication information is used to indicate at least one of the following:
assistance data related to the at least one TRP cannot be used for positioning integrity calculation; and
a first measurement quantity related to the at least one TRP cannot be used for positioning integrity calculation.

For example, the first measurement quantity includes at least one of the following:
a reference signal timing difference;
a reference signal received power;
a reference signal path received power; and
a receive-transmit timing difference of the terminal.

For example, in a case that the core network device receives the first positioning measurement information, the core network device does not calculate positioning integrity by using the assistance data related to the second error source; or
in a case that the core network device receives the second positioning measurement information, the core network device does not calculate positioning integrity by using the assistance data related to the third error source.

In this embodiment, the core network device calculates positioning integrity. In a case that the terminal performs measurement, the core network device may not calculate positioning integrity by using the assistance data related to the second error source when receiving the first positioning measurement information. That is, when positioning integrity is calculated, the assistance data related to the second error source is not considered or is excluded. In a case that the access network device performs measurement, the core network device may not calculate positioning integrity by using the assistance data related to the third error source when receiving the second positioning measurement information. That is, when positioning integrity is calculated, the assistance data related to the third error source is not considered or is excluded.

For example, the first error source includes at least one of the following:
a TRP location;
inter-TRP time synchronization;
a boresight direction of a positioning reference signal PRS; and
beam information of a PRS.

For example, the second error source includes at least one of the following:
a reference signal timing difference; and
a receive-transmit timing difference of the terminal.

For example, the assistance data related to the first error source or the second error source includes at least one of the following:
a positioning integrity bound of the first error source or the second error source; and
a positioning integrity parameter of the first error source or the second error source.

It should be noted that for an implementation of this embodiment, refer to the related descriptions of the embodiment shown in FIG. 4. Details are not described herein again.

Referring to FIG. 6, FIG. 6 is a flowchart of a positioning method according to an embodiment of this application. The method may be performed by an access network device. As shown in FIG. 6, the method includes the following steps.

Step 601: The access network device sends second positioning measurement information to a core network device, where
the second positioning measurement information includes fourth indication information, and the fourth indication information is used to indicate that assistance data related to a third error source cannot be used for positioning integrity calculation.

For example, the third error source includes at least one of the following:
a reference signal time of arrival;
a receive-transmit timing difference of the access network device; and
a reference signal angle of arrival.

For example, the assistance data related to the third error source includes at least one of the following:
a positioning integrity bound of the third error source; and
a positioning integrity parameter of the third error source.

It should be noted that for an implementation of this embodiment, refer to the related descriptions of the embodiment shown in FIG. 5. Details are not described herein again.

For ease of understanding, the following describes this embodiment of this application with reference to different scenarios by using an example.

Example 1: An LMF sends an indication that a TRP is unavailable, and a terminal or a base station calculates positioning integrity. For example, the following steps may be included.

Step a1: The LMF sends an LPP message (such as a Provide Assistance Data message) to the UE, where the LPP message includes first indication information. For example, The LPP message may further include third indication information. The first indication information is used to indicate at least one TRP that cannot be used for positioning integrity calculation or is unreliable. The third indication information is used to indicate an application range of the at least one TRP. For example, the application range may be assistance data from the LMF. That is, the third indication information is used to indicate that assistance data related to the at least one TRP cannot be used for positioning integrity calculation or is unreliable. In some embodiments, the application range may be a subsequent measurement quantity of the UE. That is, the third indication information is used to indicate that a reference signal from the unreliable TRP does not need to be measured.

Step a2: After the first indication information is received, a behavior of the UE in calculating positioning integrity includes at least one of the following:

When the UE performs UE-based downlink positioning integrity calculation or the application range indicated by the third indication information is the assistance data from the LMF, the UE does not use the assistance data, from the LMF, related to the at least one TRP indicated by the first indication information, where the assistance data, from the LMF, related to the at least one TRP may be included in a fourth error source. For the fourth error source and assistance data related to the fourth error source, refer to the foregoing descriptions. Details are not described herein again.

When the UE performs UE-based downlink positioning integrity calculation and the application range indicated by the third indication information is the subsequent measurement quantity of the UE, the UE does not measure a first measurement quantity of the at least one TRP indicated by the first indication information, or the UE does not calculate positioning integrity by using a measurement value of the first measurement quantity of the at least one TRP indicated by the first indication information.

When the UE performs only downlink positioning integrity measurement, and the LMF performs LMF-based positioning integrity calculation, and/or, the application range indicated by the received third indication information is the subsequent measurement quantity of the UE, the UE does not measure a first measurement quantity of the at least one TRP indicated by the first indication information, or measures but does not report a measurement value of the first measurement quantity of the at least one TRP indicated by the first indication information.

Example 2: The LMF sends an indication of whether assistance data related to an error source is available. For example, the following steps may be included.

Step b1: The LMF sends a first LPP message (such as a Provide Assistance Data parameter) to the UE, where the first LPP message includes first indication information, and the first indication information corresponds to a first error source and is used to indicate that assistance data related to the first error source (for example, assistance data included in the first error source) is unavailable. The first indication information may be updated based on implementation of the LMF and is usually sent along with occurrence of a feared event caused by the first error source.

For the first error source and the assistance data related to the first error source, refer to the foregoing descriptions. Details are not described herein again.

Step b2: After receiving the first indication information, the UE excludes considering the assistance data related to the first error source, that is, does not calculate positioning integrity by using the assistance data related to the first error source.

Example 3: the UE and the base station send an indication that positioning integrity measurement is unavailable.

In a case that the UE performs downlink positioning measurement, the following steps may be included.

Step c1: The UE sends an LPP message (such as a Provide Location Information message) to the LMF, where the LPP message may include second indication information, and the second indication information corresponds to a second error source and is used to indicate that assistance data related to the second error source (for example, assistance data included in the second error source) is not recommended for use. The second indication information may be updated based on implementation of the UE and is usually sent along with occurrence of a feared event caused by the second error source. For the second error source and the assistance data related to the second error source, refer to the foregoing descriptions. Details are not described herein again.

Step c2: After receiving the second indication information, the LMF excludes considering the second error source based on implementation, that is, does not calculate positioning integrity by using the assistance data included in the second error source.

In a case that the base station performs uplink positioning measurement, the following steps may be included.

Step d1: The base station sends an NRPPa message (such as a MEASUREMENT REPORT message) to the LMF, where the NRPPa message may include fourth indication information, and the fourth indication information corresponds to a third error source and is used to indicate assistance data related to the third error source (for example, assistance data included in the third error source) is not recommended for use. The fourth indication information is updated based on implementation of the UE and is usually sent along with occurrence of a feared event caused by the third error source.

For the third error source and the assistance data related to the third error source, refer to the foregoing descriptions. Details are not described herein again.

Step d2: After receiving the fourth indication information, the LMF excludes considering the third error source based on implementation, that is, does not calculate positioning integrity by using the assistance data included in the third error source.

It can be learned from the foregoing that the embodiments of this application allow the LMF to flexibly control an availability range of the positioning integrity information: for the TRP (such as all assistance data and measurement quantities associated with the TRP) or for an error source. In addition, an availability indication of the positioning integrity information is introduced on a measurement entity side to give the terminal and the base station a capability of determining whether a measurement result can be used to calculate integrity, which is helpful for final evaluation of LMF.

It should be noted that the positioning method provided in the embodiments of this application may be performed by a positioning apparatus, or a control module that is in the positioning apparatus and that is configured to perform the positioning method. In the embodiments of this application, an example in which the positioning apparatus performs the positioning method is used to describe the positioning apparatus provided in the embodiments of this application.

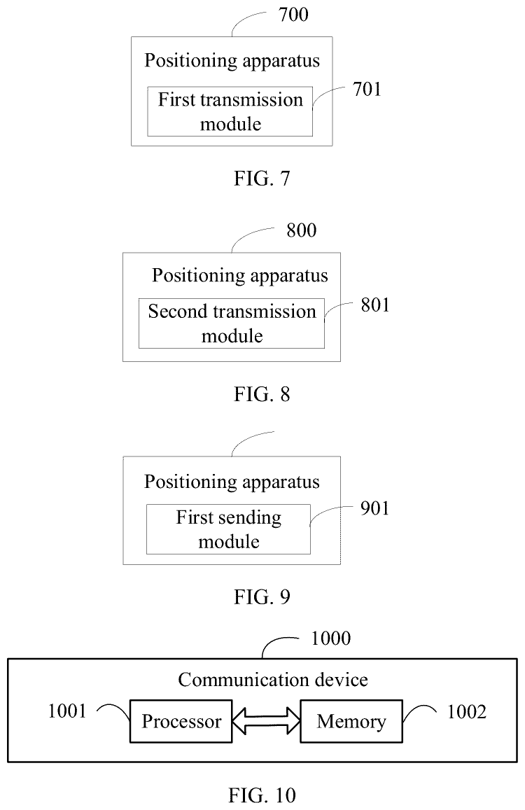

Referring to FIG. 7, FIG. 7 is a structural diagram of a positioning apparatus according to an embodiment of this application. The positioning apparatus is applied to a terminal. As shown in FIG. 7, the positioning apparatus 700 includes:
a first transmission module 701, configured to receive first positioning assistance information from a core network device, or send first positioning measurement information to the core network device, where
the first positioning assistance information includes first indication information, and the first indication information is used to indicate at least one transmission reception point TRP that cannot be used for positioning integrity calculation, or the first indication information is used to indicate that assistance data related to a first error source cannot be used for positioning integrity calculation; and
the first positioning measurement information includes second indication information, and the second indication information is used to indicate that assistance data related to a second error source cannot be used for positioning integrity calculation.

For example, in a case that the first indication information is used to indicate the at least one TRP that cannot be used for positioning integrity calculation, the terminal does not calculate positioning integrity by using assistance data related to the at least one TRP; or
in a case that the first indication information is used to indicate that the assistance data related to the first error source cannot be used for positioning integrity calculation, the terminal does not calculate positioning integrity by using the assistance data related to the first error source.

For example, the first positioning assistance information further includes third indication information, and the third indication information is used to indicate at least one of the following:
assistance data related to the at least one TRP cannot be used for positioning integrity calculation; and
a first measurement quantity related to the at least one TRP cannot be used for positioning integrity calculation.

For example, the first measurement quantity includes at least one of the following:
a reference signal timing difference;
a reference signal received power;
a reference signal path received power; and
a receive-transmit timing difference of the terminal.

For example, in a case that the terminal performs positioning integrity calculation and the third indication information is used to indicate that the assistance data related to the at least one TRP cannot be used for positioning integrity calculation, the terminal does not calculate positioning integrity by using the assistance data related to the at least one TRP; and/or
in a case that the terminal performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not calculate positioning integrity by using a measurement value of the first measurement quantity related to the at least one TRP; and/or
in a case that the core network device performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not report a measurement value of the first measurement quantity related to the at least one TRP.

For example, the first error source includes at least one of the following:
a TRP location;
inter-TRP time synchronization;
a boresight direction of a positioning reference signal PRS; and
beam information of a PRS.

For example, the second error source includes at least one of the following:
a reference signal timing difference; and
a receive-transmit timing difference of the terminal.

For example, the assistance data related to the first error source or the second error source includes at least one of the following:
a positioning integrity bound of the first error source or the second error source; and
a positioning integrity parameter of the first error source or the second error source.

The positioning apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not limited in this embodiment of this application.

The positioning apparatus provided in this embodiment of this application can implement the processes implemented in the method embodiment of FIG. 4 and achieve the same technical effect. To avoid repetition, details are not described herein again.

Referring to FIG. 8, FIG. 8 is a structural diagram of a positioning apparatus according to an embodiment of this application. The positioning apparatus is applied to a core network device. As shown in FIG. 8, the positioning apparatus 800 includes:
a second transmission module 801, configured to send first positioning assistance information to a terminal, or receive first positioning measurement information from the terminal, or receive second positioning measurement information from an access network device, where
the first positioning assistance information includes first indication information, and the first indication information is used to indicate at least one transmission reception point TRP that cannot be used for positioning integrity calculation, or the first indication information is used to indicate that assistance data related to a first error source cannot be used for positioning integrity calculation;
the first positioning measurement information includes second indication information, and the second indication information is used to indicate that assistance data related to a second error source cannot be used for positioning integrity calculation; and
the second positioning measurement information includes fourth indication information, and the fourth indication information is used to indicate that assistance data related to a third error source cannot be used for positioning integrity calculation.

For example, the first positioning assistance information further includes third indication information, and the third indication information is used to indicate at least one of the following:
assistance data related to the at least one TRP cannot be used for positioning integrity calculation; and
a first measurement quantity related to the at least one TRP cannot be used for positioning integrity calculation.

For example, the first measurement quantity includes at least one of the following:
a reference signal timing difference;
a reference signal received power;
a reference signal path received power; and
a receive-transmit timing difference of the terminal.

For example, in a case that the core network device receives the first positioning measurement information, the core network device does not calculate positioning integrity by using the assistance data related to the second error source; or
in a case that the core network device receives the second positioning measurement information, the core network device does not calculate positioning integrity by using the assistance data related to the third error source.

For example, the first error source includes at least one of the following:
a TRP location;
inter-TRP time synchronization;
a boresight direction of a positioning reference signal PRS; and
beam information of a PRS.

For example, the second error source includes at least one of the following:
a reference signal timing difference; and
a receive-transmit timing difference of the terminal.

For example, the third error source includes at least one of the following:
a reference signal time of arrival;
a receive-transmit timing difference of the access network device; and
a reference signal angle of arrival.

For example, the assistance data related to the first error source, the second error source, or the third error source includes at least one of the following:
a positioning integrity bound of the first error source, the second error source, or the third error source; and
a positioning integrity parameter of the first error source, the second error source, or the third error source.

The positioning apparatus in this embodiment of this application may be an electronic device, for example, an electronic device with an operating system, or may be a component in the electronic device, for example, an integrated circuit or a chip. The electronic device may be a core network device, or another device other than the core network device. For example, the core network device may include but is not limited to the foregoing listed types of the core network device. The another device may be a server, a Network Attached Storage (NAS), or the like. This is not limited in this embodiment of this application.

The positioning apparatus provided in this embodiment of this application can implement the processes implemented in the method embodiment of FIG. 5 and achieve the same technical effect. To avoid repetition, details are not described herein again.

Referring to FIG. 9, FIG. 9 is a structural diagram of a positioning apparatus according to an embodiment of this application. The positioning apparatus is applied to an access network device. As shown in FIG. 9, the positioning apparatus 900 includes:
a first sending module 901, configured to send second positioning measurement information to a core network device, where
the second positioning measurement information includes fourth indication information, and the fourth indication information is used to indicate that assistance data related to a third error source cannot be used for positioning integrity calculation.

For example, the third error source includes at least one of the following:
a reference signal time of arrival;
a receive-transmit timing difference of the access network device; and
a reference signal angle of arrival.

For example, the assistance data related to the third error source includes at least one of the following:
a positioning integrity bound of the third error source; and
a positioning integrity parameter of the third error source.

The positioning apparatus in this embodiment of this application may be an electronic device, for example, an electronic device with an operating system, or may be a component in the electronic device, for example, an integrated circuit or a chip. The electronic device may be an access network device, or another device other than the access network device. For example, the access network device may include but is not limited to the foregoing listed types of the access network device. The another device may be a server, a Network Attached Storage (NAS), or the like. This is not limited in this embodiment of this application.

The positioning apparatus provided in this embodiment of this application can implement the processes implemented in the method embodiment of FIG. 6 and achieve the same technical effect. To avoid repetition, details are not described herein again.

For example, as shown in FIG. 10, an embodiment of this application further provides a communication device 1000, including a processor 1001 and a memory 1002. The memory 1002 stores a program or an instruction that is executable on the processor 1001. For example, in a case that the communication device 1000 is a terminal, the program or the instruction is executed by the processor 1001 to implement the steps of the foregoing positioning method embodiment on a terminal side, and a same technical effect can be achieved. In a case that the communication device 1000 is a core network device, the program or the instruction is executed by the processor 1001 to implement the steps of the foregoing positioning method embodiment on a core network device side, and a same technical effect can be achieved. In a case that the communication device 1000 is an access network device, the program or the instruction is executed by the processor 1001 to implement the steps of the foregoing positioning method embodiment on an access network device side, and a same technical effect can be achieved. To avoid repetition, details are not described herein again.

An embodiment of this application further provides a terminal, including a processor and a communication interface, where the communication interface is configured to receive first positioning assistance information from a core network device, or send first positioning measurement information to the core network device, where the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; and the first positioning measurement information includes second indication information, and the second indication information is used to indicate that assistance data related to a second error source cannot be used for positioning integrity calculation. The terminal embodiment is corresponding to the method embodiment on the terminal side, each implementation process and implementation of the method embodiment can be applied to the terminal embodiment, and a same technical effect can be achieved. For example, FIG. 11 is a schematic diagram of a hardware structure of a terminal according to an embodiment of this application.

The terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

It is understood that the terminal 1100 may further include a power supply (such as a battery) that supplies power to each component. The power supply may be logically connected to the processor 1110 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 1104 may include a Graphics Processing Unit (GPU) 11041 and a microphone 11042. The graphics processing unit 11041 processes image data of a static picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The non-volatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1109 in this embodiment of this application includes but is not limited to these memories and any memory of another proper type.

The processor 1110 may include one or more processing units. For example, an application processor and a modem processor are integrated into the processor 1110. The application processor mainly processes an operating system, a user interface, an application, and the like. The modem processor mainly processes a wireless communication signal, for example, a baseband processor. It may be understood that, in some embodiments, the modem processor may not be integrated into the processor 1110.

The radio frequency unit 1101 is configured to receive first positioning assistance information from a core network device, or send first positioning measurement information to the core network device, where the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; and the first positioning measurement information includes second indication information, and the second indication information is used to indicate that assistance data related to a second error source cannot be used for positioning integrity calculation.

For example, in a case that the first indication information is used to indicate the at least one TRP that cannot be used for positioning integrity calculation, the terminal does not calculate positioning integrity by using assistance data related to the at least one TRP; or
in a case that the first indication information is used to indicate that the assistance data related to the first error source cannot be used for positioning integrity calculation, the terminal does not calculate positioning integrity by using the assistance data related to the first error source.

For example, the first positioning assistance information further includes third indication information, and the third indication information is used to indicate at least one of the following:
assistance data related to the at least one TRP cannot be used for positioning integrity calculation; and
a first measurement quantity related to the at least one TRP cannot be used for positioning integrity calculation.

For example, the first measurement quantity includes at least one of the following:
a reference signal timing difference;
a reference signal received power;
a reference signal path received power; and
a receive-transmit timing difference of the terminal.

For example, in a case that the terminal performs positioning integrity calculation and the third indication information is used to indicate that the assistance data related to the at least one TRP cannot be used for positioning integrity calculation, the terminal does not calculate positioning integrity by using the assistance data related to the at least one TRP; and/or
in a case that the terminal performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not calculate positioning integrity by using a measurement value of the first measurement quantity related to the at least one TRP; and/or
in a case that the core network device performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not report a measurement value of the first measurement quantity related to the at least one TRP.

For example, the first error source includes at least one of the following:
a TRP location;
inter-TRP time synchronization;
a boresight direction of a positioning reference signal PRS; and
beam information of a PRS.

For example, the second error source includes at least one of the following:
a reference signal timing difference; and
a receive-transmit timing difference of the terminal.

For example, the assistance data related to the first error source or the second error source includes at least one of the following:
a positioning integrity bound of the first error source or the second error source; and
a positioning integrity parameter of the first error source or the second error source.

An embodiment of this application further provides a network side device, including a processor and a communication interface. When the network side device is a core network device, the communication interface is configured to send first positioning assistance information to a terminal, or receive first positioning measurement information from the terminal, or receive second positioning measurement information from an access network device, where the first positioning assistance information includes first indication information, and the first indication information is used to indicate at least one TRP that cannot be used for positioning integrity calculation, or the first indication information is used to indicate that assistance data related to a first error source cannot be used for positioning integrity calculation; the first positioning measurement information includes second indication information, and the second indication information is used to indicate that assistance data related to a second error source cannot be used for positioning integrity calculation; and the second positioning measurement information includes fourth indication information, and the fourth indication information is used to indicate that assistance data related to a third error source cannot be used for positioning integrity calculation.

In some embodiments, when the network side device is an access network device, the communication interface is configured to send second positioning measurement information to a core network device, where the second positioning measurement information includes fourth indication information, and the fourth indication information is used to indicate that assistance data related to a third error source cannot be used for positioning integrity calculation.

This network side device embodiment is corresponding to the foregoing method embodiment of the network side device. Each implementation process and implementation of the foregoing method embodiment are applicable to this network side device embodiment, and a same technical effect can be achieved.

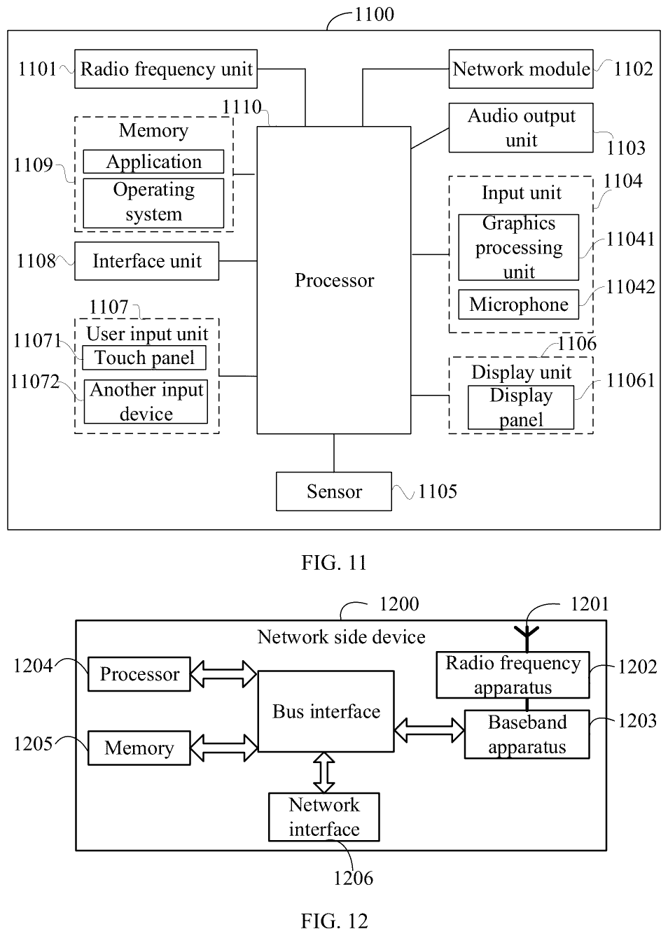

For example, an embodiment of this application further provides a network side device. As shown in FIG. 12, the network side device 1200 includes an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information through the antenna 1201, and sends the received information to the baseband apparatus 1203 for processing. In a downlink direction, the baseband apparatus 1203 processes information that needs to be sent, and sends processed information to the radio frequency apparatus 1202. The radio frequency apparatus 1202 processes the received information, and sends processed information through the antenna 1201.

In the foregoing embodiment, the method performed by the network side device may be implemented in the baseband apparatus 1203. The baseband apparatus 1203 includes a baseband processor.

For example, the baseband apparatus 1203 may include at least one baseband board. A plurality of chips are disposed on the baseband board. As shown in FIG. 12, one chip is, for example, a baseband processor, and is connected to the memory 1205 by using a bus interface, to invoke a program in the memory 1205 to perform the operations of the network device shown in the foregoing method embodiment.

The network side device may further include a network interface 1206, and the interface is, for example, a common public radio interface (CPRI).

For example, the network side device 1200 in this embodiment of this application further includes an instruction or a program that is stored in the memory 1205 and that can be run on the processor 1204. The processor 1204 invokes the instruction or the program in the memory 1205 to perform the method performed by the modules shown in FIG. 8 or FIG. 9, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing positioning method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing positioning method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing positioning method embodiment, and a same technical effect can be achieved. To avoid repetition, details are not described herein again.

An embodiment of this application further provides a positioning system, including a terminal and a core network device. The terminal is configured to perform the processes of the foregoing method embodiments in FIG. 4 and the above, and the core network device is configured to perform the processes of the foregoing method embodiments in FIG. 5 and the above, and a same technical effect can be achieved. To avoid repetition, details are not described herein again.

In some optional embodiments, the positioning system further includes an access network device. The access network device is configured to perform the processes of the foregoing method embodiments in FIG. 6 and the above, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A positioning method, comprising:
receiving, by a terminal, first positioning assistance information from a core network device,
wherein the first positioning assistance information comprises first indication information, and the first indication information is used to indicate at least one transmission reception point (TRP) that cannot be used for positioning integrity calculation, or the first indication information is used to indicate that assistance data related to a first error source cannot be used for positioning integrity calculation.

2. The method according to claim 1, wherein when the first indication information is used to indicate the at least one TRP that cannot be used for positioning integrity calculation, the terminal does not calculate positioning integrity by using assistance data related to the at least one TRP; or
when the first indication information is used to indicate that the assistance data related to the first error source cannot be used for positioning integrity calculation, the terminal does not calculate positioning integrity by using the assistance data related to the first error source.

3. The method according to claim 1, wherein the first positioning assistance information further comprises third indication information, and the third indication information is used to indicate at least one of the following:
assistance data related to the at least one TRP cannot be used for positioning integrity calculation; or
a first measurement quantity related to the at least one TRP cannot be used for positioning integrity calculation.

4. The method according to claim 3, wherein the first measurement quantity comprises at least one of the following:
a reference signal timing difference;
a reference signal received power;
a reference signal path received power; or
a receive-transmit timing difference of the terminal.

5. The method according to claim 3, wherein when the terminal performs positioning integrity calculation and the third indication information is used to indicate that the assistance data related to the at least one TRP cannot be used for positioning integrity calculation, the terminal does not calculate positioning integrity by using the assistance data related to the at least one TRP; or
when the terminal performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not calculate positioning integrity by using a measurement value of the first measurement quantity related to the at least one TRP; or
when the core network device performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not report a measurement value of the first measurement quantity related to the at least one TRP.

6. The method according to claim 1, wherein the first error source comprises at least one of the following:
a TRP location;
inter-TRP time synchronization; or
beam information of a PRS.

7. The method according to claim 1, further comprising:
sending, by the terminal, first positioning measurement information to the core network device,
wherein the first positioning measurement information comprises second indication information, and the second indication information is used to indicate that assistance data related to a second error source cannot be used for positioning integrity calculation, and
wherein the second error source comprises at least one of the following:
a reference signal timing difference; or
a receive-transmit timing difference of the terminal.

8. The method according to claim 1, wherein the assistance data related to the first error source comprises:
a positioning integrity bound of the first error source.

9. A positioning method, comprising:
sending, by a core network device, first positioning assistance information to a terminal,
wherein the first positioning assistance information comprises first indication information, and the first indication information is used to indicate at least one transmission reception point (TRP) that cannot be used for positioning integrity calculation, or the first indication information is used to indicate that assistance data related to a first error source cannot be used for positioning integrity calculation.

10. The method according to claim 9, wherein the first positioning assistance information further comprises third indication information, and the third indication information is used to indicate at least one of the following:
assistance data related to the at least one TRP cannot be used for positioning integrity calculation; or
a first measurement quantity related to the at least one TRP cannot be used for positioning integrity calculation.

11. The method according to claim 10, wherein the first measurement quantity comprises at least one of the following:
a reference signal timing difference;
a reference signal received power;
a reference signal path received power; or
a receive-transmit timing difference of the terminal.

12. The method according to claim 9, wherein the first error source comprises at least one of the following:
a TRP location;
inter-TRP time synchronization; or
beam information of a PRS.

13. The method according to claim 9, wherein the assistance data related to the first error source comprises:
a positioning integrity bound of the first error source.

14. A terminal, comprising a processor and a memory storing a program or an instruction that, when executed by the processor, cause the terminal to perform operations comprising:
receiving first positioning assistance information from a core network device,
wherein the first positioning assistance information comprises first indication information, and the first indication information is used to indicate at least one transmission reception point (TRP) that cannot be used for positioning integrity calculation, or the first indication information is used to indicate that assistance data related to a first error source cannot be used for positioning integrity calculation.

15. The terminal according to claim 14, wherein when the first indication information is used to indicate the at least one TRP that cannot be used for positioning integrity calculation, the terminal does not calculate positioning integrity by using assistance data related to the at least one TRP; or
when the first indication information is used to indicate that the assistance data related to the first error source cannot be used for positioning integrity calculation, the terminal does not calculate positioning integrity by using the assistance data related to the first error source.

16. The terminal according to claim 14, wherein the first positioning assistance information further comprises third indication information, and the third indication information is used to indicate at least one of the following:
assistance data related to the at least one TRP cannot be used for positioning integrity calculation; or
a first measurement quantity related to the at least one TRP cannot be used for positioning integrity calculation.

17. The terminal according to claim 16, wherein the first measurement quantity comprises at least one of the following:
a reference signal timing difference;
a reference signal received power;
a reference signal path received power; or
a receive-transmit timing difference of the terminal.

18. The terminal according to claim 16, wherein when the terminal performs positioning integrity calculation and the third indication information is used to indicate that the assistance data related to the at least one TRP cannot be used for positioning integrity calculation, the terminal does not calculate positioning integrity by using the assistance data related to the at least one TRP; or
when the terminal performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not calculate positioning integrity by using a measurement value of the first measurement quantity related to the at least one TRP; or
when the core network device performs positioning integrity calculation and the third indication information is used to indicate that the first measurement quantity related to the at least one TRP cannot be used for positioning integrity calculation, the terminal does not measure the first measurement quantity related to the at least one TRP, or the terminal does not report a measurement value of the first measurement quantity related to the at least one TRP.

19. The terminal according to claim 14, wherein the first error source comprises at least one of the following:
a TRP location;
inter-TRP time synchronization; or
beam information of a PRS.

20. The terminal according to claim 14, wherein the assistance data related to the first error source comprises:
a positioning integrity bound of the first error source.
